(19) United States
(12) Patent Application Publication
(10) Pub. No.: US 2022/0057495 A1
(43) Pub. Date: Feb. 24, 2022

(54) LIDAR DETECTION DEVICE PROVIDED WITH A RELEASABLE PROTECTIVE LAYER

(71) Applicant: AGC GLASS EUROPE, Louvain-la-Neuve (BE)

(72) Inventors: Romain DACQUIN, Basecles (BE); Yannick SARTENAER, Vedrin (BE); Xavier GILLON, Saint-Servais (BE); Giovanni REA, Gosselies (BE); Nerio LUCCA, Fleurus (BE)

(73) Assignee: AGC GLASS EUROPE, Louvain-la-Neuve (BE)

(21) Appl. No.: 17/414,619

(22) PCT Filed: Dec. 17, 2019
(86) PCT No.: PCT/EP2019/085741

§ 371 Date: Jun. 16, 2021

(30) Foreign Application Priority Data
Dec. 21, 2018 (EP) 18215130.8
Feb. 5, 2019 (EP) 19155519.2

(51) Int. Cl. G01S 7/497; G01S 7/481; G01S 17/931

(52) U.S. Cl. CPC G01S 7/497; G01S 2007/4977; G01S 17/931; G01S 7/4813

(57) ABSTRACT

A Light Detection and Ranging (LiDAR) detection device with a releasable protective layer including a solid-state LiDAR device enclosed in a housing provided with a transparent wall portion made of glass or polymer. A releasable protective layer covers the outer surface of the transparent wall portion, such that the releasable protective layer protects the transparent wall portion from multiple impacts by gravel as defined in SAE J400, the releasable protective layer has a mean transmittance of at least 90%, preferable at least 95% to an IR-radiation in the wavelength range from 750 to 1650 nm, and the transparent wall portion covered with the releasable protective layer has a mean transmittance of at least 85%, preferably at least 90%, more preferably at least 92% to IR-radiation.

### TECHNICAL FIELD

The present invention is in the field of detection devices suitable for use in automotive vehicles to assist a driver (ADAS=Advanced Driver Assistance System), including autonomous or self-driving vehicles. More particularly, the present invention concerns a LiDAR system composed of a housing and a solid-state LiDAR device lodged in the housing, having an increased service time and reliability at very low cost. The present invention concerns a removable protective layer applied on an outer surface of a transparent wall portion of the housing. When damaged to a point that IR transmission or haze are out of the required values for a reliable functioning of the LiDAR system, the protective layer can be removed and replaced by a new one.

### BACKGROUND OF THE INVENTION

Automotive vehicles are being equipped by more and more systems for assisting a driver of a vehicle. These are collectively referred to as ADAS (=Advanced Driver Assistance System). ADAS comprise detection systems able to detect and, in some cases, identify an obstacle in the immediate surrounding of the vehicle. For example, detection systems include optical or IR-cameras, radars, and LiDARs (=light detection and ranging). A LiDAR measures the distance between itself and objects in its field of view by calculating the time taken by a pulse of light to travel at the light speed to an object and back to the LiDAR. It comprises a light emitter, usually a laser source, and a light receiver. As a pulse of light emitted by the light emitter of a LiDAR hits an object of irregular shape, the incident light signal gets scattered and only a fraction of the light returns to the light receiver. US20150029487 describes an automotive vehicle equipped with a LiDAR-type device.

Mechanical scanning LiDARs constitute a first generation of LiDARs, using a powerful collimated laser source and concentrating the return signal on the receiver through highly focused optics. By rotating the laser and receiver assembly, the mechanical scanning LiDAR can scan the area around it and collect data over a wide area of up to 360 degrees. Mechanical scanning LiDARs are, however, generally bulky, delicate and very expensive. Solid-state LiDARs are a second generation of LiDARs that do not have the drawbacks of mechanical scanning LiDARs.

When mechanical scanning LiDARs rely on an electromechanical construction for scanning a single laser source over an area around it, solid-state LiDARs comprise no moving parts. Solid state LiDARs use an optical phased array wherein optical emitters send out bursts of photons in specific patterns and phases to create directional emission, of which the focus and size can be adjusted. An optical phased array is a row of emitters (e.g., laser) that can change the direction of an electromagnetic beam by adjusting the relative phase of the signal from one emitter to the next. A solid-state LiDAR is built on an electronic chip and is therefore much cheaper and resistant to vibrations than a mechanical scanning LiDAR. One drawback of solid-state LiDARs compared with a mechanical scanning LiDAR comprising a single laser source is that for a same energy consumption, the intensity of light emitted by an optical phased array is divided by the number of optical emitters. Optical phenomena like reflection, absorption, and scattering of light can become more problematic than with a single source of laser.

Solid-state LiDARs are being implemented more and more in automotive vehicles. They can be mounted on an exterior of an automotive vehicle which is a very aggressive environment exposed to rain, hail, large temperature variations, and impacts with various objects including gravel. To protect LiDARs from such environment, LiDAR devices are enclosed in a housing comprising a transparent wall portion which is transparent to the wavelength used by the LiDAR. LiDARs can use UV-, visible, or IR-light. LiDARs used in the automotive industry, however, generally emit light in the near infrared spectrum comprised between 750 and 1650 nm. The transparent wall portion must of course maintain a high transmittance to the light emitted by the light sources. For this reason, many automotive producers include a wiping system ensuring that the transparent wall portion remains clean. A wiping system, however, does not prevent the transparent wall portion from being degraded by various impacts with objects such as gravel, producing scratches on an outer surface of the transparent wall portion. The transparent wall portion can become scratched to a point wherein transmittance is reduced, or haze is increased to a point wherein the LiDAR device is not reliable anymore. To date, when this happens, the transparent wall portion is not replaced, but the whole LiDAR system must be changed, generating costs to the users. Similarly, in case the transparent wall portion is broken by an impact, the LiDAR device is not protected anymore from the outer aggressions, and the whole LiDAR system must be replaced.

With the evolution of the ADAS and of the autonomous vehicles requiring a multitude of detection system, it is not acceptable having to change a LiDAR system every time the transparent wall portion of the housing is scratched. The present invention proposes a solution to this problem allowing the service life of a LiDAR system to be substantially enhanced at low cost compared with the present systems. These and other advantages are described in more details in the following sections.

### SUMMARY OF THE INVENTION

The present invention is defined in the appended independent claims. Preferred embodiments are defined in the dependent claims. In particular, the present invention concerns a detection device comprising,
(a) a solid-state Light Detection and Ranging (LiDAR) device, enclosed in
(b) a housing provided with a transparent wall portion made of a glass or a polymer,
   Characterized in that, a releasable protective layer covers an outer surface of the transparent wall portion, and in that,
(c) the releasable protective layer protects the transparent wall portion from multiple impacts by gravel as defined in SAE J400 or in ISO 20567-1:2017,
(d) the releasable protective layer has a mean transmittance of at least 90%, preferably at least 95% to an IR-radiation in the wavelength range from 750 to 1650 nm, and the transparent wall portion covered with the releasable protective layer has a mean transmittance of at least 85%, preferably at least 90%, more preferably at least 92%, to the IR-radiation.

The releasable protective layer can be one of,
A glass sheet of thickness equal or below to 5 mm, preferably below to 2 mm, said glass sheet being adhered to the transparent wall portion preferably by an adhesive,
A polymer sheet of thickness of 1000 μm or less, preferably not more than 500 μm, said polymer sheet being adhered to the transparent wall portion preferably by an adhesive, or
A coated layer applied onto the outer surface of the transparent wall portion by dip-coating, spraying, or sputtering, and which can be removed with a solvent, or by a heat treatment.

In a preferred embodiment, the releasable protective layer can be one of,
A glass sheet of thickness not more than 1 mm, preferably not more than 0.7 mm, said glass sheet being adhered to the transparent wall portion preferably by an adhesive,
A polymer sheet of thickness not more than 500 μm, preferably not more than 150 μm, said polymer sheet being adhered to the transparent wall portion preferably by an adhesive, or
A coated layer applied onto the outer surface of the transparent wall portion by dip-coating, spraying, or sputtering, and which can be removed with a solvent, or by a heat treatment.

The releasable protective layer preferably confers to a transparent wall portion covered thereby a resistance to multiple impacts by stone-chips as defined in SAE J400 such that, after removal of the protective layer, the outer surface of the transparent wall portion has a rating of at least 8A and 8B, preferably at least 9A and 9B for size categories A&B corresponding to impact sizes of not more than 3 mm, and preferably of 10C and 10D for size categories C&D corresponding to impact sizes greater than 3 mm.

Alternatively, or concomitantly, the releasable protective layer can confer to a transparent wall portion covered thereby a resistance to multiple impacts by metal grits as defined in method A of ISO 20567-1:2017 such that, after removal of the protective layer, the outer surface of the transparent wall portion has an affected area of not more than 0.2% after a test with a rating of 0.5.

In a preferred embodiment, the releasable protective layer is a laminate comprising an antireflection layer including one of a low refractive index porous silica. Alternatively, it can be a laminate of several layers of dielectric material alternating layers having low and high refractive indexes and terminating in a layer having a low refractive index, or mixtures thereof. The releasable protective layer preferably has a reflectance to the IR-radiation of less than 7%, preferably less than 5%.

Unless defined otherwise, when the expression “IR-radiation” is used, it refers to a radiation of wavelength comprised between 750 to 1650 nm.

In a preferred embodiment, the transparent wall portion covered by the releasable protective layer is characterized by a haze, of not more than 3% preferably not more than 2%, as measured according to ASTM-D1003-11, Procedure A, using a hazemetre. In a preferred embodiment, the releasable protective layer preferably has a mean transmittance to visible light of wavelength comprised between 400 and 700 nm, lower than 60%, preferably lower than 20%, more preferably lower than 5%. In yet a preferred embodiment, the releasable protective layer preferably has a hydrophobic outer surface, exposed to atmosphere when covering the transparent wall portion. An hydrophobic surface is defined as a surface on which a water droplet forms a static contact angle of at least 90°.

In one embodiment, the releasable protective layer is a soda lime glass sheet. Alternatively, the releasable protective layer can be a polymer sheet comprising polyurethane, polycarbonate, polyester, copolymers or blends thereof.

The detection device is preferably mounted on an automotive vehicle. For example, the housing excluding the transparent wall portion can be an integral part of a non-transparent element of an automotive vehicle including a fender, a bumper, a grill, a wing mirror cover, a rear-view mirror cover, a bonnet, a boot, a side door, a pillar, or a back door, a lens reflector. In another example, the transparent wall portion can be a part of a transparent component of an automotive vehicle, including a front windscreen, a rear window, a lateral window, a headlight or tail light cover.

The present invention also concerns the use of a releasable protective layer as defined supra for protecting a transparent wall portion of a housing enclosing a solid-state LiDAR.

The present invention also concerns a method for repairing a detection device as defined supra, wherein an outer surface of the releasable protective layer comprises a damaged area, said method comprising the following steps,
(a) removing the releasable protective layer comprising the damaged area from the outer surface of the transparent wall portion, and
(b) applying onto the outer surface of the transparent wall portion a new releasable protective layer so that it adheres to and can be removed from the outer surface of the transparent wall portion.

The removal of the releasable protective layer comprising the damaged area can comprise the use of mechanical force, of a solvent or of a thermal treatment.

The new releasable protective layer can be a glass or a polymer sheet. The glass or polymer sheet can be adhered to the outer surface of the transparent wall portion by an adhesive which can be removed mechanically, by a solvent, or by a thermal treatment.

The present invention also concerns an automotive vehicle comprising a detection device as defined supra, wherein the vehicle is preferably a self-driving vehicle.

### BRIEF DESCRIPTION OF THE FIGURES

For a fuller understanding of the nature of the present invention, reference is made to the following detailed description taken in conjunction with the accompanying drawings in which:

FIG. 1: illustrates the behaviour of an incident radiation (i0) traversing a transparent wall portion.

FIG. 2: shows an exploded view of a detection device according to the present invention.

FIG. 3: shows schematically various stages of the use of a detection device according to the present invention with a repair following an impact with gravel.

FIG. 4: shows an automotive vehicle with various locations where a detection device according to the present invention can be located.

FIG. 5: shows three embodiments of integration of a detection device according to the present invention in an automotive vehicle: (a) a complete detection device is coupled to a (non-transparent) body portion of the vehicle, (b) the non-transparent wall portion of the housing is an integral part of a body portion of the vehicle, and (c) the transparent wall portion of the housing is a transparent element of the vehicle.

### DETAILED DESCRIPTION OF THE INVENTION

As illustrated in FIG. 2, the present invention concerns a detection device comprising a solid-state LiDAR device (21) enclosed in a housing (11) provided with a transparent wall portion (12) made of a glass or a polymer. The LiDAR must be enclosed in a housing to protect it from external aggressions, such as dirt and impacts from gravel or hail. The present invention proposes a solution for prolonging the service life of a LiDAR system, by concentrating wear to a sacrificial layer. The sacrificial layer can be replaced at low cost when a detection device is rendered unreliable by wear leading to a degradation of the optical properties of the transparent wall portion.

As discussed above, solid-state LiDAR comprise a phase array of optical emitters (lasers) which create a beam of optical waves that can be electronically steered to point in different directions without moving the optical emitters. Each optical emitter is set with a phase relationship such that the optical waves from the separate emitters add together to increase the radiation in a desired direction, while cancelling to suppress radiation in undesired directions. In a phased array, a beam of optical waves can be steered to a different direction by controlling the phase shift between emitters.

To protect the solid state LiDAR from external aggressions, it is enclosed in a housing comprising a transparent wall portion to allow the passage of emitted radiations as well as of returned radiation bounced back on an obstacle.

### Transparent Wall Portion (12)

The emitted radiations must traverse the transparent wall portion (12) of the housing (11) until they hit an obstacle and part of the radiations are reflected back to the detection device, where they must traverse the transparent wall portion (12) again before reaching an optical sensor. The transparent wall portion (12) to be traversed by the incident beam (i0) and a return beam reflected off an obstacle must have a high transmittance to infrared light, commonly used in LiDARs mounted on automotive vehicles (40). It can be made of polymer or of glass.

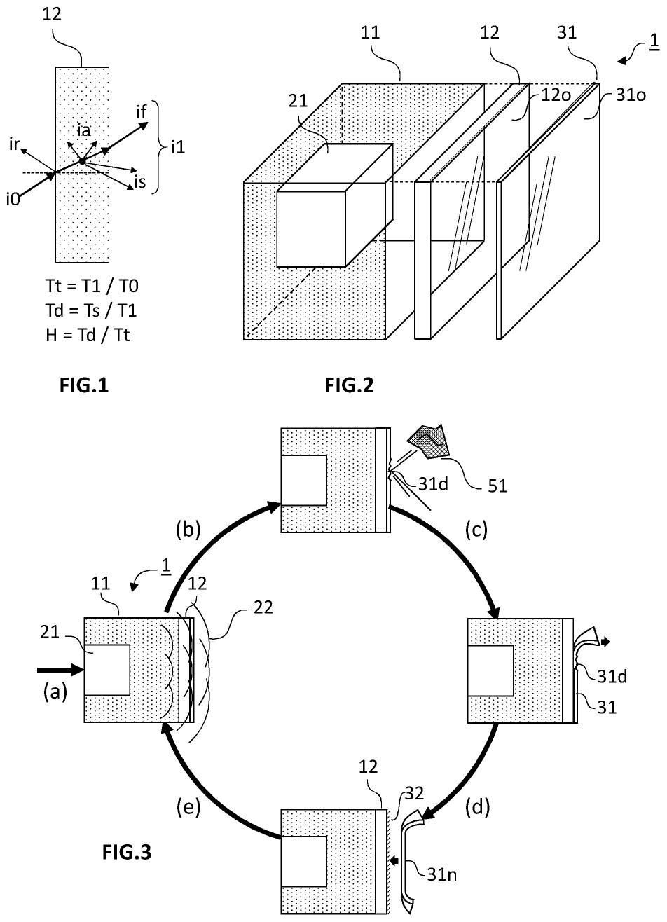

As shown in the simplified illustration of FIG. 1, an incident radiation (i0) traversing a transparent wall portion (12) can be split into one or more of a reflected radiation (ir), an absorbed radiation (ia), a scattered radiation (is), and a refracted radiation (if). The reflected radiation (ir) and absorbed radiation (ia) do not traverse the transparent wall portion. Referring to ASTM-D1003-11, § 7.2&7.3,
the transmittance, Tt, is equal to the ratio, T1/T0, of the flux, T1, of radiation having traversed the transparent wall portion to the flux, T0, of incident radiation, (i0), wherein the flux T1 is the sum of fluxes (Tf+Ts) of the refracted radiation (i1) and the scattered radiation (is).
The diffuse transmittance, Td, is the ratio, Ts/T1, of the flux, Ts, of scattered radiation to the flux, T1, of transmitted radiation.
Haze, H, is equal to the ratio, Td/Tt, of the diffuse transmittance, Td, to the transmittance, Tt.

It is essential for the good functioning of the LiDAR detection device (1) that the transparent wall portion (12) has, on the one hand, a high transmittance, Tt, to the wavelengths emitted by the LiDAR, which are generally comprised within the IR-range, preferably between 750 to 1650 nm and, on the other hand, a low value of the haze (H). Examples of transparent wall portions suitable for use with LiDAR detection devices are described in US20150029487 and in EP20170185156 and the patent application PCT/EP2018/070954. It is important for the service life of the LiDAR detection device that these values be maintained during use of a vehicle, exposing the transparent wall portion (12) to external aggressions including rain, frost, and impacts from hail and gravels. In particular hail and gravel can of course break the transparent wall portion, but even merely scratching the outer surface (12o) of the transparent wall portion (12) may increase the haze value, thus decreasing the accuracy of the return signal recorded by the optical sensor of the LiDAR device.

### Protective Layer (31)

To prevent the permanent degradation of the outer surface (12o) of the transparent wall portion (12) by external aggressions, including impacts by hail and gravels, the present invention proposes to cover the outer surface (12o) of the transparent wall portion with a releasable protective layer (31). The protective layer (31) protects the outer surface (12o) of the transparent wall portion (12) from permanent damage by multiple impacts by gravel as defined in SAE J400 or in ISO 20567-1:2017.

With the present invention, it is the releasable protective layer (31) which is exposed to the external aggressions including impacts by hail or gravel. As illustrated in FIG. 3, a new detection device according to the present invention can be mounted on an automotive vehicle (cf. FIG. 3(a)) and used. As shown in FIG. 3(b) the releasable protective layer (31) can be degraded by impacts by gravel (5) or any other object, including hail, forming a degraded area (31d). With time and use the degraded area (31d) can become damaged to a point where the optical properties of transmittance, Tt, and/or haze, H, fall below predefined reliability threshold defining a level below which the LiDAR detection device (1) is not reliable anymore. With prior art detection devices, the whole detection device would have to be removed and replaced by a new detection device, increasing the costs substantially. With the present invention and as illustrated in FIG. 3(c), the damaged releasable protection layer (31) can be removed from the outer surface (12o) of the transparent wall portion (12). The outer surface (12o) of the transparent wall portion (12) is not damaged, or very little damaged, because it was protected by the releasable protective layer (31) which absorbed all or much of the energy of the external aggressions in the degraded area(s) (31d). As shown in FIG. 3(d), a new releasable protective layer (31) can be applied onto the outer surface (10) of the transparent wall portion (12), allowing the LiDAR detection device to function reliably again, with a sufficient transmittance, Tt, and a sufficiently low haze, H, to generate clear and reliable signals.

In one embodiment, the releasable protective layer (31) can be a glass sheet which can be adhered to the transparent wall portion e.g., by an adhesive. Any pressure sensitive adhesive (PSA) available on the market can be used, provided that, on the one hand, it allows the removal of the glass sheet, e.g., using a solvent (other than water because of the rain), heat, or mechanical force and, on the other hand, it does not affect the optical properties of transmittance and haze to IR-radiations below the reliability threshold.

For reducing absorption of IR-radiations, the glass sheet should be as thin as possible. On the other hand, the releasable protective layer (31) must protect the outer surface (12o) of the transparent wall portion (12) and absorb most of the energy of impacts with gravel and hail. Glass being brittle to impacts, a thicker glass sheet would therefore also be advantageous. Balancing these two contradictory requirements, it is preferred that the glass sheet have a thickness of not more than 1 mm, preferably not more than 0.7 mm. The glass sheet preferably has a thickness of at least 0.2 mm, preferably at least 0.4 mm. The glass sheet can have a thickness of 0.6±0.2 mm.

The glass sheet forming the releasable protective layer (31) can be a soda lime glass sheet. An example of soda lime glass composition comprises the following components:

| | |
|---|---|
| SiO₂ | 55-85% |
| Al₂O₃ | 0-30% |
| B₂O₃ | 0-20% |
| Na2O | 0-25% |
| CaO | 0-20% |
| MgO | 0-15% |
| K₂O | 0-20% |
| BaO | 0-20% |
| Cr₂O₃ | 0.0001-0.06%. |
| Co | 0-1% |
| Total iron (expressed as Fe₂O₃) | 0.002-1%. |

Another example of soda lime glass composition comprises the following components:

| | |
|---|---|
| SiO₂ | 55-85% |
| Al₂O₃ | 0-30% |
| B₂O₃ | 0-20% |
| Na₂O | 0-25% |
| CaO | 0-20% |
| MgO | 0-15% |
| K₂O | 0-20% |
| BaO | 0-20% |
| Cr₂O₃ | 0.0001-0.8%. |
| Co | 0-1% |
| Total iron (expressed as Fe₂O₃) | 0.002 1.7%. |

Another embodiment for soda-lime glass composition dedicated to high transmittance in IR-radiations from 1050 to 1650 nm combined with a very low transmission in the visible part of the electromagnetic spectrum, replaces the Cr2O3, Fe2O3 and Co ranges given just above by the following one:

| | |
|---|---|
| total iron (expressed as Fe2O3) | 0.002-1.1%; |
| Manganese (expressed as MnO) | 0.005%; |
| and optionally, | |
| Chromium (expressed as Cr2O3) | 0-1.3%, |

and having:
the sum (Fe2O3+MnO+Cr2O3) of the contents of total iron, manganese and chromium, expressed as weight percentages, ≤1%
the ratio R1 defined as Fe2O3*/(49+0,43(Cr2O3*−MnO*))<1; and
the ratio R2 defined as Fe2O3*/(34+0,3(Cr2O3*−MnO*))<1; Fe2O3*, MnO* and Cr2O3* being relative percentages with respect to the sum (Fe2O3+MnO+Cr2O3).

Such glass sheet has a very high transmittance to IR-radiations used by LiDARs detection devices in automotive vehicles. The transparent wall portion (12) can also be made of glass. Preferably, the transparent wall portion (12) is made of glass and has a composition within the ranges defined supra for the glass sheet. If the releasable protective layer and the transparent wall portion (12) are both made of glass having same (or similar) compositions, adhesion between the two glasses would be enhanced, requiring less adhesive, or a cheaper adhesive or even no adhesive at all, provided the two surfaces are smooth and mate perfectly. For safety, however, it is preferred to use at least some adhesive.

In an alternative embodiment, the releasable protective sheet can be a polymer sheet, said polymer sheet being adhered to the transparent wall portion e.g., by an adhesive. The polymer sheet can be made of polyurethane, polycarbonate, polyester, copolymers or blends thereof. Many polymers are substantially more ductile than glass and have a greater ability of absorbing impact energy from hitting gravel. Polymer sheets can be thinner than corresponding glass sheets, and preferably have a thickness of not more than 500 μm, preferably not more than 150 μm.

As for glass sheets, the adhesive can be a PSA which must allow the removal of the polymer sheet and must not affect the optical properties of the assembly of transparent wall portion and polymer sheet. It must also be adhesively compatible with the polymer sheet. Unlike glass, polymers generally have lower surface energies, so that all adhesives do not adhere satisfactorily to a surface of a polymer sheet. A person of ordinary skill in the art can find in the catalogues of suppliers a list of adhesives suitable for each type of polymer.

The transparent wall portion (12) can be made of glass of composition within the ranges defined supra for the glass sheet. Glasses generally have a high surface energy and adhere well to PSAs, so that a PSA suitable for adhering to a polymer sheet generally adheres well to a glass surface. Alternatively, the transparent wall portion (12) can be made of a polymer. Preferably the polymer of the transparent wall portion is compatible with, preferably of the same family, as the polymer of the polymer sheet. In these conditions the choice of a PSA adhesively compatible with both transparent wall portion and releasable protective layer is made easier. In some cases, adhesion between the two surfaces is possible without an adhesive. For safety, it is preferred to use at least some adhesive.

In a third embodiment, the releasable protective layer can be a coated layer applied onto the outer surface (12o) of the transparent wall portion (12) by any known technique such as, dip-coating, spraying, or sputtering. The coating must be removable with a solvent, other than water (because of rain), by a heat treatment which does not affect negatively the transparent wall portion the coating is adhered to, or by mechanically scraping the coating.

The outer surface (12o) of the transparent wall portion (12) can have a three-dimensional (3D-) geometry. The releasable protective layer (31) must mate the three-dimensional geometry of the outer surface. In case of a glass sheet, it should be performed to mate the 3D-geometry of the outer surface (12o). A polymer sheet is generally flexible enough to mate any geometry. A coating obviously mates any geometry.

### Optical Properties of the Protective Layer (31)

The releasable protective layer (31) of the present invention must have a mean transmittance of at least 85%, preferably at least 90%, more preferably at least 92%, and even of at least 95% to an IR-radiation in the wavelength range from 750 to 1650 nm. When applied to the outer surface (12o) of the transparent wall portion (12), the assembly of the transparent wall portion covered by the releasable protective layer has a mean transmittance of at least 85%, preferably at least 90%, more preferably at least 92% to the IR-radiation.

The releasable protective layer (31) can have a mean transmittance to visible light of wavelength comprised between 400 and 700 nm, lower than 60%, preferably lower than 20%, more preferably lower than 5%. The releasable protective layer can be treated to have a coloured outer surface, either by application of a coloured layer or dyed in the bulk of the releasable protective layer. For example, the releasable protective layer can be black or can have a colour matching the body colour of the vehicle it is applied to.

Reducing the reflection caused by the releasable protective layer is of course very important as it can increase the transmittance. Reflection reduction can be enhanced by applying an antireflection layer to the releasable protective layer (31). The releasable protective layer (31) can therefore be a laminate comprising an antireflection layer including one of a low refractive index porous silica, or is a laminate of several layers of dielectric material alternating layers having low and high refractive indexes and terminating in a layer having a low refractive index, or mixtures thereof. The releasable protective layer preferably has a reflectance to the IR-radiation of less than 7%, preferably less than 5%, more preferably less than 3%, wherein the reflectance is defined as the ratio, Tr/T0, of the flux, Tr, of reflected light (ir) to the flux T0, of incident light (i0).

An assembly of a transparent wall portion covered by a (new) releasable protective layer preferably has a haze, H, of not more than 3% preferably not more than 2%, as measured according to ASTM-D1003-11, Procedure A, using a hazemetre. Haze is a source of uncertainty which reduces the accuracy of the LiDAR detection device. Haze therefore should preferably be kept as low as possible.

Because rain and frost can temporarily disrupt the optical properties of the assembly of a transparent wall portion (12) and a releasable protective layer (31), the latter can comprise a hydrophobic outer surface (31o), exposed to atmosphere when covering the transparent wall portion (12). The hydrophobicity can be obtained either by the choice of a polymer sheet or coating having a low surface energy, or by applying a hydrophobic layer to the releasable protective layer (31). A surface is considered as being hydrophobic when a water droplet laid on the surface forms a static water contact angle greater than 90°.

Most optical properties of materials are provided by the supplier's technical sheets. A preselection of optically suitable materials for the releasable protective layer can therefore be made on catalogue. The materials of the preselection can be tested in order to confirm the official data. Optical properties may vary with thickness of the layer and with the quality grade of the material.

The optical properties discussed supra ensure that the releasable protective layer does not hinder the good functioning of the LiDAR detection device based on transmission of light beams through a transparent wall portion. The main objective of the releasable protective layer (31), however, is the protection of the outer surface (12o) of the transparent wall portion (12). This can be achieved with the mechanical properties discussed below.

### Mechanical Properties of the Protective Layer (31)

The releasable protective layer (31) preferably confers to a transparent wall portion covered thereby a resistance to multiple impacts by stone-chips as defined in SAE J400 such that, after removal of the protective layer, the outer surface (12o) of the transparent wall portion has a rating of at least 8A and 8B, preferably at least 9A and/or 9B or even of 10A and/or 10B for size categories A&B corresponding to impact sizes of not more than 3 mm, and of preferably 10C and 10D for size categories C&D corresponding to impact sizes greater than 3 mm. The impact test method according to SAE J400 is described more in details below.

Alternatively, or additionally, the releasable protective layer (31) can confer to a transparent wall portion covered thereby a resistance to multiple impacts by metal grits as defined in method A of ISO 20567-1:2017, such that, after removal of the protective layer, the outer surface (12o) of the transparent wall portion has an affected area of not more than 0.2% after a test, with a rating 0.5.

Both test methods SAE J400 and ISO 20567-1:2017 are actually tests designed for reproducing the effect of gravel or other media striking exposed painted surfaces of an automobile. Both methods comprise an evaluation step consisting of assessing the area of chipped paint, which is absent from the outer surface (12o) of the transparent wall portion. The outer surface of the transparent wall portion, if damaged by the test, comprises dents. A contrasted view of the dents can be enhanced by taking a photographs of the outer surface (12o) with a low-angled light. Alternatively, the outer surface can be coated with a coloured layer applied with a roller, taking care of applying no colour inside the dents.

If a releasable protective layer (31) fulfilling the optical requirements described supra does confer to the transparent wall portion it is applied on the mechanical requirements as defined by SAE J400 or ISO 20567-1:2017, the test can be repeated with a releasable protective layer of same composition but having a larger thickness. Care must be taken that the optical requirements are still fulfilled with the new, larger thickness. If the mechanical requirements are still not reached, then an alternative material must be selected. In case of insufficient mechanical properties of a glass sheet, it can be hardened by chemical or thermal quenching and tested again with same thickness first and, if not satisfactory, with a layer thickness.

### Impact Test Method SAE J400

SAE J400 describes a test method for testing resistance to chipping of coated surfaces. The test is designed to reproduce the effect of gravel or other media striking exposed paint or coated surfaces of an automobile. The test consists of projecting standardized road gravel of size comprised between 9.5 and 15.9 mm space screen by means of a controlled air blast onto a surface test panel. The test method C at ambient temperature is applied here.

The results are given in terms of chip rating by a number category between 10 and 0 defining a density or number per unit area of chips (10 refers to low chip density, and 0 to high chip density), and of size categories A to D defining the size of the chips, with A referring small sizes and D to large sizes.

For example, a chip rating of 8A corresponds to 2 to 4 chips of size less than 1 mm per specimen (10.6×10.6 cm). A chip rating of 9B corresponds to 1 chip of size comprised between 1 and 3 mm per specimen. The rating 10 corresponds to no chip. The foregoing ratings are agreeable ratings of the outer surface of a transparent wall portion after testing and after removal of the releasable protective layer. SAE J400 gives a series of standard patterns for helping in the rating of a chipped surface by comparison with the standard patterns.

### Impact Test Method ISO 20567-1:2017

Test method ISO 20567-1:2017 is similar to the SAE J400 test method with the difference that instead of gravel, chilled iron grit of mesh size comprised between 3.55 and 5 mm according to a defined size distribution is projected against the surface to be tested. Chilled iron grit is more reproducible and durable than gravel which erodes rapidly after each testing session. The test panels are 100×100 mm in size. According to test method A, 2 times 500 g of grit is projected in 20 s with a pressure of 100 kPa.

Like with SAE J400, the evaluation of the damage to the outer surface (12o) caused by the test after removal of the releasable protective layer can be completed by comparison with standard patterns. The patterns span over a range of ratings comprised between 0.5 and 5.0 in steps of 0.5. The outer surface (12o) after removal of the releasable protective layer (31) preferably has a rating of 0.5 or lower, i.e., corresponding to the smallest standard pattern provided in the norm.

Automotive Vehicle Provided with a Detection Device

A detection device according to the present invention is particularly suitable for use in automotive vehicles, ships, airplanes, and the like. Preferably, a detection device according to the present invention is mounted on an automotive vehicle, more preferably on a self-driving automotive vehicle. Automotive vehicles include cars, vans, lorries, motor bikes, buses, trams, trains, and the like.

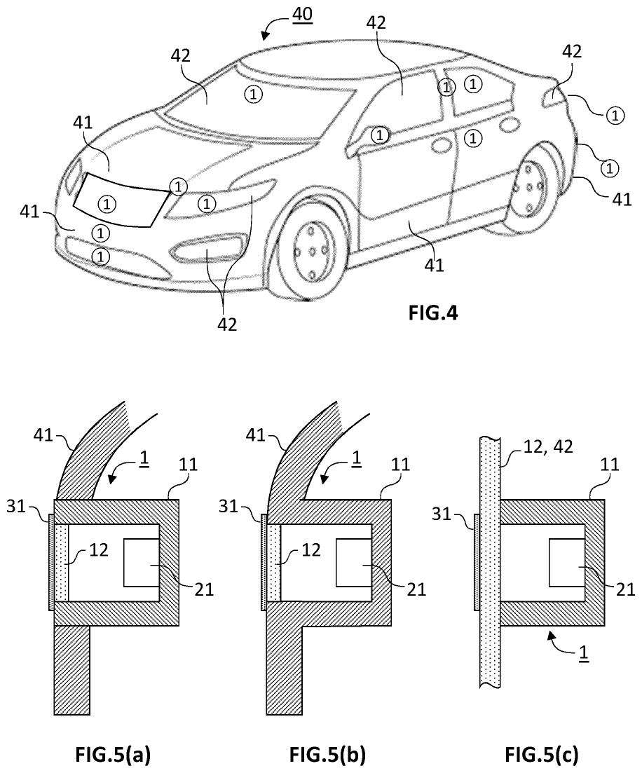

FIG. 4 shows a typical car and also shows examples of localizations of detection devices by the enclosed numeral (1). Detection devices can be mounted on non-transparent body elements (41) including fenders, bumpers, grills, wing mirror covers, rear-view mirror cover, bonnet, boot, side doors, a pillar, or back doors, lens reflectors. Detection devices can also be mounted behind transparent body elements (42) including front windscreen, rear window, lateral windows, headlight or tail light covers, and the like.

FIG. 5 shows various options for mounting a detection device according to the present invention on a vehicle, with the transparent wall portion facing outwards; In FIG. 5(a), a non-transparent element (41) of the body of a vehicle is provided with an opening for fitting the housing (11) of a detection device (1). The detection device can be fixed to the body by any means well known to a person of ordinary skill in the art, such as welding, screws, snap-fitting, and the like.

In FIG. 5(b), the housing (11) excluding the transparent wall portion (12) can be an integrated part of a non-transparent element (41) of the body of a vehicle (40). The transparent wall portion (31) can be glued to a perimeter of the opening after having installed the LiDAR device. As discussed supra, a non-transparent element (41) of an automotive vehicle (40), can include a fender, a bumper, a grill, a wing mirror cover, a rear-view mirror cover, a bonnet, a boot, a side door, a pillar, or a back door, a lens reflector, and the like (cf. FIG. 4).

A third option illustrated in FIG. 5(c) is to fix the housing (11) excluding the transparent wall portion (12) to an inner surface of a transparent element (42) of the vehicle (40). The transparent wall portion is thus formed by a part of the transparent element of the automotive vehicle. Transparent elements (42) of a vehicle suitable for receiving a detection device include a front windscreen, a rear window, a lateral window, a headlight or tail light cover, and the like (cf. FIG. 4).

In all of the foregoing options, a releasable protective layer can be applied to the outer surface (12o) of the transparent wall portion (12). The present invention therefore concerns the use of a releasable protective layer (31) as defined supra for protecting a transparent wall portion (12) of a housing enclosing a solid-state LiDAR.

The present invention also concerns a method for repairing a detection device as discussed supra, wherein an outer surface (31o) of the releasable protective layer (31) comprises a damaged area (31d), said method comprising the following steps.
(a) Removing the releasable protective layer (31) comprising the damaged area from the outer surface (12o) of the transparent wall portion (12). Removal of the damaged releasable protective layer can be assisted by use of a solvent (different from water), application of heat, or by mechanical scraping.
(b) Applying to the outer surface (12o) of the transparent wall portion (12) a new releasable protective layer (31n) so that it adheres to and can be removed from the outer surface (12o) of the transparent wall portion (12). An adhesive, such as a PSA can be used to ensure a good adhesion of the releasable protective layer to the outer surface of the transparent wall portion. Any blister appearing at the interface between the two could disrupt the optical properties of the assembly formed by the transparent wall portion covered by the releasable protective portion. The adhesive must be selected as discussed supra, such that it has suitable optical properties, suitable adhesive compatibility with both surfaces to be adhered and it must allow the removal of the new releasable protective layer, with or without assistance of a solvent, heat, or mechanical scraping.

The present invention provides a solution for prolonging the service life of detection devices by application on the outer surface (12o) of a transparent wall (12) a releasable protective layer (31). The releasable protective layer (31) acts as a sacrificial layer which can be removed when worn and replaced by a new releasable protective layer. This solution is substantially cheaper and ecological than changing the whole detection device, in case the dysfunction of the device (1) is due to reduced optical properties of the transparent wall portion (and releasable protective layer) of the housing.

| REF# | Feature |
|---|---|
| 1 | Detection device |
| 11 | Housing |
| 12 | Transparent wall portion |
| 12o | Outer surface of the transparent wall porton |
| 21 | Solid state LiDAR |
| 22 | IR radiation |
| 31 | Releasable protective layer |
| 31d | Damaged area of the releasable protective layer |
| 31n | New releasable protective layer |
| 31o | Outer surface of the releasable protective layer |
| 32 | Adhesive |
| 40 | Automotive vehicle |
| 41 | Non-transparent body element |
| 42 | Transparent body element |
| 51 | Gravel |
| i0 | Incident radiation |
| i1 | Transmitted radiation |
| ia | Absorbed radiation |
| if | Diffracted radiation |
| ir | Reflected radiation |
| is | Scattered radiation |
| T0 | flux of incident radiation |
| T1 | flux of incident radiation |
| Td | Diffuse transmittance = Ts / Tl |
| Ts | Flux of scattered radiation |
| Tt | transmittance |

1. A detection device comprising:
(a) a solid-state Light Detection and Ranging (LiDAR) device, enclosed in
(b) a housing provided with a transparent wall portion made of a glass or a polymer,
wherein a releasable protective layer covers an outer surface of the transparent wall portion, and in that,
(c) the releasable protective layer protects the transparent wall portion from multiple impacts by gravel as defined in SAE J400 or in ISO 20567-1:2017,
(d) the releasable protective layer has a mean transmittance of at least 90% to an IR-radiation in the wavelength range from 750 to 1650 nm, and
(e) the transparent wall portion covered with the releasable protective layer has a mean transmittance of at least 85% to the IR-radiation.

2: The detection device according to claim 1, wherein the releasable protective layer is selected from the group consisting of,
a glass sheet of thickness of equal or below to 5 mm, with said glass sheet being adhered to the transparent wall portion,
a polymer sheet of thickness of 1000 μm or less, with said polymer sheet being adhered to the transparent wall portion, and
a coated layer applied onto the outer surface of the transparent wall portion by dip-coating, spraying, or sputtering, and which can be removed with a solvent, or by a heat treatment.

3: The detection device according to claim 1, wherein the releasable protective layer is selected from the group consisting of,
a glass sheet of thickness not more than 1 mm, with said glass sheet being adhered to the transparent wall portion,
a polymer sheet of thickness not more than 500 μm, with said polymer sheet being adhered to the transparent wall portion, and
a coated layer applied onto the outer surface of the transparent wall portion by dip-coating, spraying, or sputtering, and which can be removed with a solvent, or by a heat treatment.

4: The detection device according to claim 1, wherein
the releasable protective layer has a resistance to multiple impacts by stone-chips as defined in SAE J400, such that, after removal of the protective layer, the outer surface of the transparent wall portion has a rating of at least 8A and 8B for size categories A&B corresponding to impact sizes of not more than 3 mm, and a rating of 10C and 10D for size categories C&D corresponding to impact sizes greater than 3 mm, and/or
the releasable protective layer confers to the transparent wall portion covered thereby a resistance to multiple impacts by metal grits as defined in method A of ISO 20567-1:2017 such that, after removal of the protective layer, the outer surface of the transparent wall portion has an affected area of not more than 0.2% after a test with a rating of 0.5.

5: The detection device according to claim 1, wherein the releasable protective layer is a laminate comprising an antireflection layer including one of a low refractive index porous silica, or is a laminate of several layers of dielectric material alternating layers having low and high refractive indexes and terminating in a layer having a low refractive index, or mixtures thereof, and wherein the releasable protective layer has a reflectance to the IR-radiation of less than 7%.

6: The detection device according to claim 1, wherein the transparent wall portion covered by the releasable protective layer is characterized by a haze, of not more than 3% as measured according to ASTM-D1003-11, Procedure A, using a hazemetre.

7: The detection device according to claim 1, wherein the releasable protective layer has a mean transmittance to visible light of wavelength between 400 and 700 nm, lower than 60%.

8: The detection device according to claim 1, wherein the releasable protective layer has a hydrophobic outer surface, exposed to atmosphere when covering the transparent wall portion.

9: The detection device according to claim 1, wherein the releasable protective layer is a soda lime glass sheet.

10: The detection device according to claim 1, wherein the releasable protective layer is a polymer sheet comprising polyurethane, polycarbonate, polyester, copolymers or blends thereof.

11: The detection device according claim 1, wherein
the housing excluding the transparent wall portion is an integral part of a non-transparent element of an automotive vehicle, including a fender, a bumper, a grill, a wing mirror cover, a rear-view mirror cover, a bonnet, a boot, a side door, a pillar, or a back door, a lens reflector, and/or
the transparent wall portion is a part of a transparent component of an automotive vehicle, including a front windscreen, a rear window, a lateral window, a headlight or tail light cover.

12. (canceled)

13: A method for repairing the detection device according to claim 1, wherein an outer surface of the releasable protective layer comprises a damaged area, said method comprising:
(a) removing the releasable protective layer comprising the damaged area from the outer surface of the transparent wall portion,
(b) applying to the outer surface of the transparent wall portion a new releasable protective layer so that it adheres to and can be removed from the outer surface of the transparent wall portion.

14. The method according to claim 13, wherein the removing of the releasable protective layer comprising the damaged area comprises the use of mechanical force, of a solvent or of a thermal treatment.

15: The method according to claim 12 or 13, wherein the new releasable protective layer is a glass or a polymer sheet, and wherein the glass or polymer sheet is adhered to the outer surface of the transparent wall portion by an adhesive which can be removed mechanically, by a solvent, or by a thermal treatment.

16: Automotive vehicle comprising the detection device according to claim 1.

17: The detection device according to claim 1, wherein the releasable protective layer has a mean transmittance of at least 95% to an IR-radiation in the wavelength range from 750 to 1650 nm.

18: The detection device according to claim 1, wherein the transparent wall portion covered with the releasable protective layer has a mean transmittance of at least 92%.

19: The detection device according to claim 1, wherein the releasable protective layer has a mean transmittance to visible light of wavelength comprised between 400 and 700 nm, lower than 20%.

20: The detection device according to claim 1, wherein the releasable protective layer has a mean transmittance to visible light of wavelength comprised between 400 and 700 nm, lower than 5%.

21: The detection device according to claim 1, wherein the transparent wall portion covered by the releasable protective layer is characterized by a haze, of not more than 2%, as measured according to ASTM-D1003-11, Procedure A, using a hazemetre.
